(19) United States
(12) Patent Application Publication
(10) Pub. No.: US 2003/0101072 A1
(43) Pub. Date: May 29, 2003

(54) Document protection system

(76) Inventors: John D. Dick, Indianapolis, IN (US); Kevin K. Kirkpatrick, Indianapolis, IN (US); Marjorie J. Patterson, Cicero, IN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/264,220

(22) Filed: Nov. 22, 2002

Related U.S. Application Data
(60) Provisional application No. 60/333,778, filed on Nov. 28, 2001.

(51) Int. Cl. G06F 17/60

(52) U.S. Cl. 705/1

(57) ABSTRACT

A method and system for providing a consumer with on-line access to a real estate transaction file is provided. The method includes the steps of verifying that a completed real estate transaction file is in compliance with applicable regulations, preparing the file for conversion into digital form, converting the file into a suitable digital form, checking a quality of the converted file, indexing the converted file for storage in an online database connected to a network, storing the converted file in the online database in accordance with a predetermined document retention policy, and providing the consumer with secure electronic access to the converted file over the network.

### CROSS-REFERENCE TO RELATED APPLICATION

This application claims the benefit of U.S. Provisional Patent Application Serial No. 60/333,778, filed Nov. 28, 2001, which is incorporated herein by this reference.

### TECHNICAL FIELD

The present invention relates to business methods and computer software. In particular, the present invention relates to a system and method for storing, protecting, and providing access to consumer real estate transaction documents.

### BACKGROUND AND SUMMARY

Computer systems that contain document management functions are common today. Also, in the world of consumer real estate transactions, online services are available to aid consumers in locating buyers or sellers, during the process of buying and selling real estate. See, for example, U.S. Pat. No. 5,584,025 to Keithley et al. Computer systems directed to assisting the business entities involved in real estate transactions, such as mortgage lenders, are also prevalent. See, for example, U.S. Pat. No. 5,995,947 to Fraser et al.

However, there is a need for greater protection for consumers storing their real estate transaction documents once the real estate transaction is closed. For tax reasons and other purposes, such as estate planning, refinancing, resale or remodeling of the home, insurance, boundary disputes or litigation, these documents must be retained by the consumer for an extended period of time, yet must remain easily accessible by the consumer. Storage of these important documents in the consumer's home is often not satisfactory because of the risk of unexpected events such as fire, flood, theft, or accidental loss of the documents. Buying or selling a home is often a hectic time for consumers, and the documents can be easily misplaced. A reliable document protection system for consumers who have been involved in real estate transactions is therefore desirable. In particular, a secure online service, which focuses on proper storage, protection, and retrieval of the consumer's important real estate transaction documents after the real estate transaction is closed, is needed.

In accordance with the present invention, a method for providing a consumer with on-line access to a completed real estate transaction file is provided. The method includes the steps of verifying that a completed real estate transaction file is in compliance with applicable regulations, preparing the file for conversion into digital form, converting the file into a suitable digital form, checking a quality of the converted file, indexing the converted file for storage in an online database connected to a network, storing the converted file in the online database in accordance with a predetermined document retention policy, and providing the consumer with secure electronic access to the converted file over the network.

In one embodiment, the method further includes the steps of designating a consumer and a real estate agent as authorized parties, providing the authorized parties with access to the file over the network, and denying access to the file by parties who are not designated as authorized parties.

In another embodiment, the method includes the steps of receiving a first file associated with a buyer, receiving a second file associated with a seller, storing the second file separately from the first file, designating the buyer and the real estate agent as authorized parties with respect to the first file, designating the seller and the real estate agent as authorized parties with respect to the second file, and limiting access to the first and second files to the respective designated parties.

In a further embodiment, a document protection system is provided. In accordance with the present invention, the document protection system includes means for storing a file including at least one document relating to a closed real estate transaction involving a real estate agent and a consumer represented by the real estate agent, means for enabling access to the file over a network by authorized parties, means for designating the consumer and the real estate agent as authorized parties, and means for denying access to the file by non-authorized parties.

### BRIEF DESCRIPTION OF THE DRAWINGS

FIG. 1 shows a flow diagram of an embodiment of the method of the present invention;

FIG. 2 shows a block diagram of an embodiment of the system of the present invention;

FIG. 3 shows a flow diagram of an embodiment of the process of providing consumer access to documents in the system of the present invention;

FIG. 4 shows a login screen display of a consumer interface of the illustrated embodiment of the system of the present invention;

FIG. 5 shows a document access screen display of a consumer interface of the illustrated embodiment;

FIG. 6 shows a document search screen display of an agent interface of the illustrated embodiment;

FIG. 7 shows a search results screen display of an agent interface of the illustrated embodiment; and

FIG. 8 shows a document search screen display of an office interface of the illustrated embodiment.

### DETAILED DESCRIPTION OF THE DRAWINGS

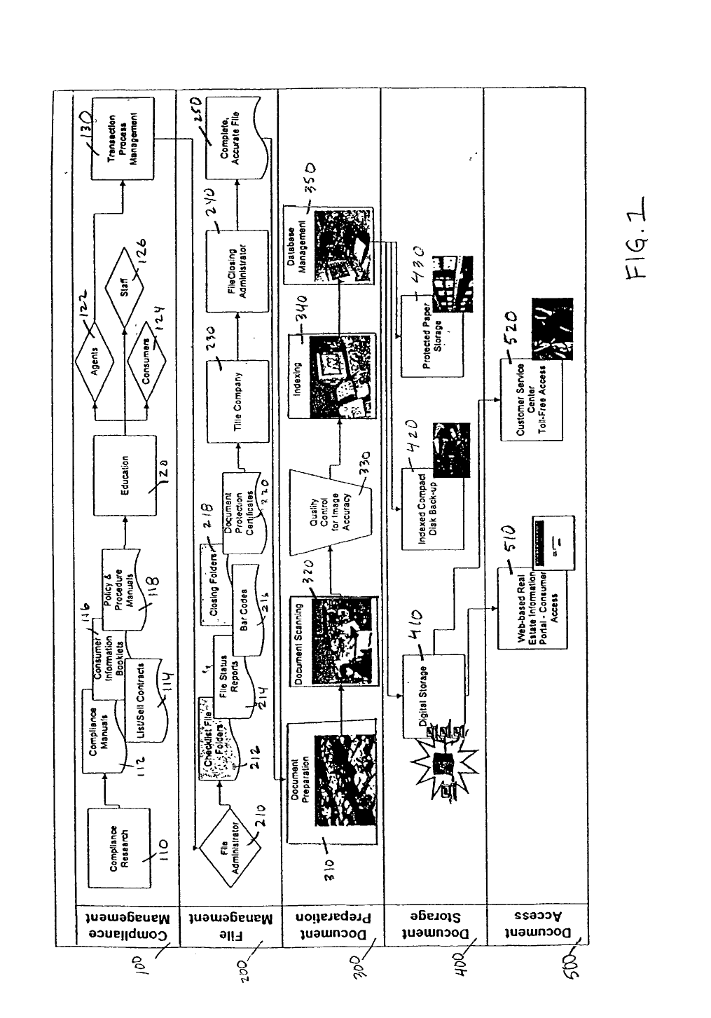

The embodiment of the document protection method of the present invention shown in FIG. 1 includes five phases: compliance management 100, file management 200, document preparation 300, document storage 400, and document access 500. However, it is understood that other embodiments within the scope and spirit of the present invention may not include all of the phases described in FIG. 1, or may not include all of the specific steps, deliverables, or participants identified in each phase, or may include phases, steps, deliverables, and participants in addition to those described in FIG. 1. For example, in an alternative embodiment of file management phase 200, bar codes 216 are not provided.

Compliance management phase 100 involves the performance of steps directed to educating participants to ensure that a consumer's real estate transaction documents are stored and managed in compliance with all applicable laws, rules, and regulations, including real estate license laws, realtor codes, and tax regulations. Illustratively, these steps are performed by persons employed by a real estate agency or brokerage office, but may also be performed by independent contractors engaged by a real estate agency or brokerage office for this purpose. As shown in FIG. 1, the compliance management phase 100 includes three primary steps: compliance research 110, education 120, and transaction process management 130.

During the compliance research step 110, the applicable laws, rules and regulations affecting the real estate industry, and any recent updates thereto, are studied by a person implementing the method of the present invention, for example, a real estate agent or a consultant retained by a real estate office. Such laws, rules and regulations include, for example, state real estate license laws, the National Association of REALTORS code of ethics, federal laws such as the Fair Housing Act, the Americans with Disabilities Act, the Gramm-Leach Bliley Act, and state and federal sex offender registration laws. As a result of this research, certain deliverables are created. These deliverables include, for example, compliance manuals 112; new, updated, or revised listing contracts or selling contracts 114; consumer information booklets 116; and policy and procedure manuals 118.

Illustratively, consumer information booklets 116 describe all disclosures required of a consumer with respect to a real estate transaction, as well as other issues affecting the transaction. Compliance manuals 112 include, for example, a reproduction or summary of state real estate license laws, realtor codes, rules and regulations.

Policy and procedure manuals 118 illustratively include policies, procedures, and guidelines for compliance with the applicable laws, rules, and regulations. Such policies, procedures and guidelines may include, for example, a rule that no listing will be entered at the agency until a complete listing file is received, or that no sale will be established as pending until a complete pending purchase file is received, or that an agent will not receive his or her commission until a complete closing file is received.

In general, compliance manuals 112, contracts 114, and policy and procedure manuals 118 are directed to the real estate agents 122 and staff 126, while consumer information booklets 116 are directed to consumers 124—the persons buying or selling real estate. It is understood that the deliverables 112, 114, 116 and 118 may be provided in hard copy or electronic form, for example, on CD-ROM or via the Internet, such as through a World Wide Web interface. Compliance research step 110 is performed initially but may also be performed periodically as changes are made to the applicable laws, rules, and regulations or new laws, rules, or regulations are adopted.

The deliverables 112, 114, 116, and 118 are used by brokerage staff and agents at education step 120. During education step 120, staff 126 and agents 122 are educated and informed of the applicable laws, rules and regulations and any recent changes thereto. In the illustrated embodiment, training is conducted separately for staff 126 and agents 122. It is contemplated that such training can be provided either in a traditional setting with a human instructor or on-line, e.g., via a Web-based software application, or using a combination of each of these methods.

Agents 122 perform transaction process management at step 130. Since the agents 122 interact directly with consumers 124 during the real estate transaction, each agent 122 is responsible for compiling a real estate transaction file, including transaction documents and closing documents, for each of his or her consumers. It is understood that the real estate transaction file may be compiled in paper form or, if the documents are available electronically, on-line. Once the transaction file is complete, it is provided to a file administrator 210.

File management phase 200 begins with receipt by file administrator 210 of a consumer's transaction file, as shown in FIG. 1. File administrator 210 checks to make sure that the transaction file is complete, i.e., that all items required to be in the transaction file for the consumer are actually in the file, and that all such items contain accurate and complete information. It is understood that in a paper-based environment, file administrator 210 may be a human being, such as a staff member 126. However, if the transaction file is available on-line, file administrator 210 may be implemented as a series of computer software routines executing logic to ensure completeness of the file. In a computer implementation, software compares the contents of the transaction file against an electronic checklist to verify accuracy and completeness of the file and its contents. Also, in a computer implementation, the electronic checklist is created, updated, and maintained electronically.

A checklist 212 of mandatory documents is created for each transaction file. Mandatory documents include all documents that are required to be retained in the transaction file for compliance with applicable laws, rules, regulations, policies and procedures. For example, purchase agreements must be retained in the transaction files for both buyers and sellers, and all such agreements must be fully executed. In the illustrated embodiment, checklist 212 includes a list of mandatory documents as well as questions or rules, such as: “have both parties signed and dated the purchase agreement?” that are used to determine whether the file and its contents are accurate.

Certain documents are designated as mandatory for both buyers and sellers, while others are required only for buyers, or only for sellers. For example, in one embodiment, the deed, vendor's affidavit, seller's residential disclosure, purchase agreement, inspection report, survey, title commitment, and HUD statement are designated as mandatory documents for both buyer and seller transaction files, but mortgage payoff statements and listing contracts are mandatory documents only for sellers, while the mortgage, note, and mortgage riders are mandatory documents only for buyers.

Buyer and seller transaction files are generally required to be kept separate from one another. Accordingly, each buyer and each seller is assigned a unique, confidential identifier. Also, in one embodiment wherein the transaction files are paper files, the files are color coded (e.g., blue for buyers, yellow for sellers) to facilitate proper separation. In another embodiment, where the transaction files are available electronically, visual or audio indicators may be used (such as the color of the file name or graphic associated with the file), in addition to the unique buyer and seller identifiers, to facilitate separating and distinguishing buyer and seller transaction files.

In the illustrated embodiment of file management phase 200, file status reports 214, bar codes 216, closing folders 218, and document protection certificates 220 are generated by file administrator 210. These deliverables 214, 216, 218, and 220 may be generated and maintained electronically on-line, or manually. File status reports 214 include information pertaining to the status of the real estate transaction, i.e., whether the transaction is in the listing phase (property listed, but no sale pending), purchase phase (offer is pending), closing phase (offer has been accepted), or post-closing phase (sale of property is complete), as well as an indication of the accuracy and completeness of the file and its contents.

Also during file management phase 200, a unique identifier is generated for each transaction file, via a bar code 216 or other means of providing identification information, such as a magnetic strip, or infrared transmission. This unique identifier includes the consumer's unique identifier, an indication of whether the consumer is a buyer or a seller, and, if necessary, a unique identifier for the transaction (for example, a code identifying the property involved in the transaction).

Although buyer and seller transaction files are maintained separately, and neither buyer nor seller has access to the other's transaction files, in the event that a real estate broker or agency represents both buyer and seller in a given transaction, the agency will have access to both buyer and seller files for that transaction. Also, the real estate agent or members of the agency staff may generate additional documents related to a transaction that are kept separately from both the buyer or seller transaction files. Such documents include, for example, notes, communication logs, and accounting documents. These documents are assigned an additional identifier corresponding to the representing agent or agency, so that they will only be accessible by the agent or agency that created them.

Closing folders 218 are generally received after the listing files and purchase files. A quality review is conducted of the closing files or folders 218 to determine accuracy and completeness. This review is illustratively conducted by file administrator 210, which, as discussed above, may be a human being or may be implemented electronically via computer programming.

Document protection certificates 220 are secure digital certificates assigned to each consumer who requests on-line access to their transaction documents. The technology for implementing digital certificates is well known in the art. In the illustrated embodiment, each certificate 220 includes a user name, password, unique identifier (which includes information to determine whether the consumer is a buyer or seller), and expiration date. The expiration date is a predetermined date after which the certificate, and thus the consumer's access to the on-line service will expire, such as a future anniversary date of the closing of the consumer's real estate transaction. The expiration date is generally determined by reference to applicable laws, rules, and regulations.

The title company 230 involved in a real estate transaction is contacted during file management phase 200. Title company 230 is requested to provide copies of the consumer's closing documents for storage in the system of the present invention. One embodiment of the present invention includes an on-line interface with title company 230 whereby the closing documents are requested, transmitted, and received electronically within the system of the present invention. In other embodiments, the closing documents are requested and/or received via e-mail, telephone, fax or written communication. A file closing administrator 240 verifies that the closing file is accurate and complete. In one embodiment in which closing documents are all received electronically, administrator 240 is implemented electronically via computer software programmed to check the closing file and its contents after receipt from title company 230. In another embodiment, administrator 240 is an employee of or independent contractor associated with a real estate agent in charge of monitoring and verifying closing files. Completion of file management phase 200 results in delivery of a complete, accurate consumer real estate transaction file 250.

During document preparation phase 300, the real estate transaction file is prepared for digital storage. If the transaction file and/or any of its contents are received in paper form, those documents are prepared for digital scanning at step 310 of FIG. 1. Document preparation activities include inspection and improvement (when possible) of the clarity of the document text, removal of staples and paper clips, and repair of documents that are torn or otherwise in poor physical condition. At step 320, documents received in paper form are converted to digital form. In the illustrated embodiment, a scanner is used to create digital reproductions of the transaction documents, however, another device could also be used, such as a digital camera or digital copier. The technology for converting paper documents into digital form is well known in the art, and any suitable digital format may be used.

If the transaction file and/or any of its contents is already in digital form, the above-described conversion step is not necessary. However, it may be desirable to convert the file or documents from one digital format to another, if compatibility with computer systems used by the consumers or the real estate agents is an issue, or if a more secure document form is desired. For example, it may be desirable to convert documents received in an editable word processor format (such as Microsoft Word) to a “read-only” format such as PDF.

At step 330 of document preparation phase 300, the digital version of the transaction file (whether it be a digital image of a paper document or an electronic document) is inspected for accuracy to ensure that the conversion undertaken at step 320 accurately translated all portions of the document. Computer software known in the art may be employed to perform or assist in the performance of this step. At step 340, each digital transaction document is indexed so that it is associated with the proper transaction file, consumer, and real estate agent. Technology for indexing digital documents is common in today's database software. In one embodiment, indexing is accomplished by linking real estate transaction data from an existing database program commonly used in the industry (such as the commercially available software known as Crest) with the corresponding transaction documents.

At step 350, one or more on-line databases are created that will store the indexed document. These databases are further described below.

During document storage phase 400, the indexed transaction files and their contents are stored for a period of time determined by reference to a document retention policy derived from the applicable laws, rules, regulations, guidelines, policies and procedures of the compliance management phase 100. In the illustrated embodiment, three forms of storage are used. Digital storage 410 stores the transaction files electronically to be available to the consumer and the real estate agent via a World Wide Web interface on the Internet. Two forms of back-up storage are also used: optical storage 420 using an optical storage medium such as a CD-ROM or DVD, and storage of the original paper documents in a water-tight, firesafe vault 430.

During document access phase 500, each consumer's transaction documents are made available to the consumer via an electronic interface connected to a communications network. In the illustrated embodiment, a Web-based portal is provided for consumer access at step 510. A traditional telephone hotline number is also provided, at step 520, particularly for consumers who may be unable to access the Web portal themselves. A service representative with access to the consumer's documents is assigned to respond to the consumer's telephone requests, or this step may be automated using voice recognition technology so that upon receipt via telephone of the user's proper identification information and document request, computer software triggers online retrieval of the requested documents, which can then be electronically faxed to the consumer or printed and sent by regular postal mail.

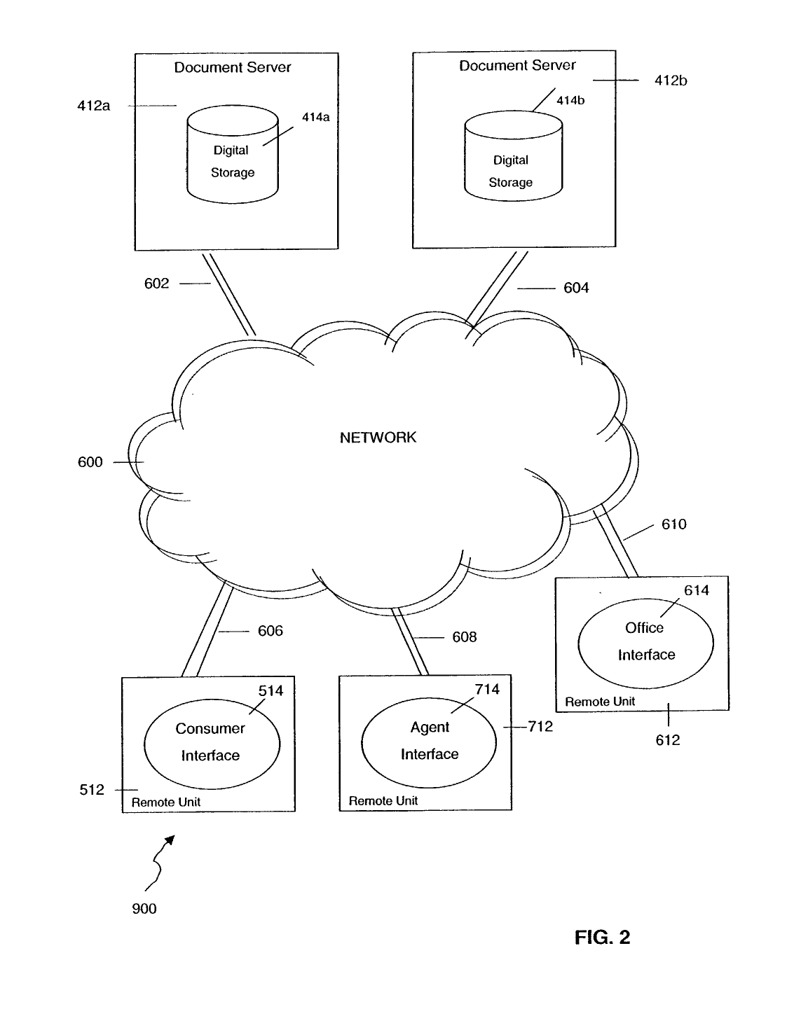

A block diagram of an embodiment 900 of the system of the present invention is shown in FIG. 2. First document server 412a, second document server 412b, first remote unit 512, second remote unit 712, and third remote unit 612 are connected via secure network connections 602, 604, 606, 608 and 610 to communications network 600.

First document server 412a is a live, dedicated server used for primary storage of the transaction documents. The server may be located on-site at the real estate agency or brokerage office, or may be housed at another location, for example, if it is hosted by a third party provider of hosting services. Second document server 412b is a back-up server. In one embodiment, second server 412b is used only for storing a copy of the data and documents. In another embodiment, second server 412b is a redundant back-up server that is also capable of providing on-line access to the data and documents in the event that first document server 412a is unavailable. A third server (not shown), also used for back-up, but housed at a different location, is employed in one embodiment. Additional servers may be used depending on the size and volume of documents, or other factors. One of ordinary skill in the art would be able to readily determine the appropriate configuration of servers for document storage depending, for example, upon the anticipated number of files to be stored.

The indexed real estate transaction documents are stored in digital storage 414a. A back-up copy of these documents is stored in digital storage 414b. Digital storage 414a and 414b are implemented using a suitable commercially available database product, such as Oracle. One of ordinary skill in the art would be able to select an appropriate database product. Each of digital storages 414a, 414b may comprise a single database, or a group of interconnected databases, as appropriate, for a particular implementation of document storage. One of ordinary skill in the art would be able to determine an appropriate database configuration, for example, based on the number of documents and document types, the type of searching and retrieval desired, performance requirements (such as fast, efficient searching), and other factors. Also, security measures, such as firewalls, are employed to restrict access to the storages 414a, 414b to only the authorized parties.

Remote units 512, 612, and 712 are computers, such as desktop or laptop microcomputers, handheld digital assistants (PDAs), or other remote computing devices capable of linking to a communications network and supporting display of consumer interface 514, office interface 614, and agent interface 714, respectively.

Consumer interface 514, office interface 614, and agent interface 714 are graphical user interfaces driven by computer software to be displayed on remote units 512, 612, 712. In the illustrated embodiment, interfaces 514, 614, 714 are displayed to the end user (the consumer or agent) via a Web portal. One of ordinary skill in the art would be able to select a suitable user interface development application and determine other necessary software development tools to construct the computer programs described herein.

In the illustrated embodiment, network 600 is a global communications network, such as the Internet. It is understood that a private network or sub-network of limited access may also be used. In addition, access to the network may be provided via telephone modem, cable modem, wireless network connection, or other currently available network means.

Communications links 602, 604, 606, and 608 are secure network connections configured to deny access to the documents by unauthorized parties. Illustratively, access is controlled through the use of unique user names and passwords, however, other methods, such as digital signatures, may be used. Additionally, to protect documents from authorized access during transmission to remote units 512, 612, 712, a form of encryption, or other analogous security measures, may be used.

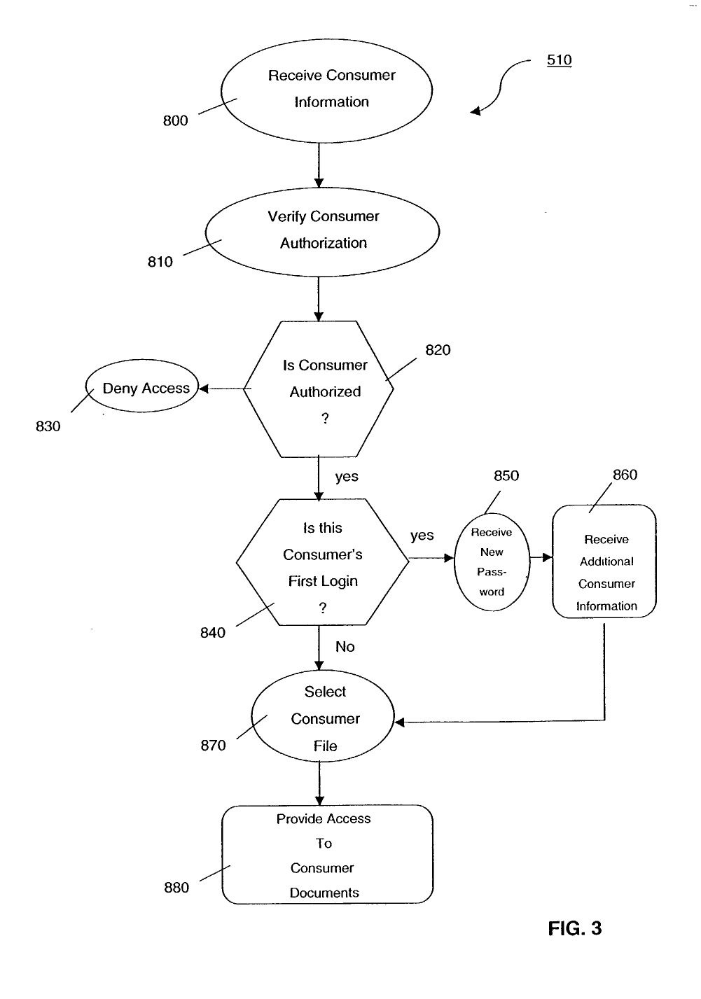

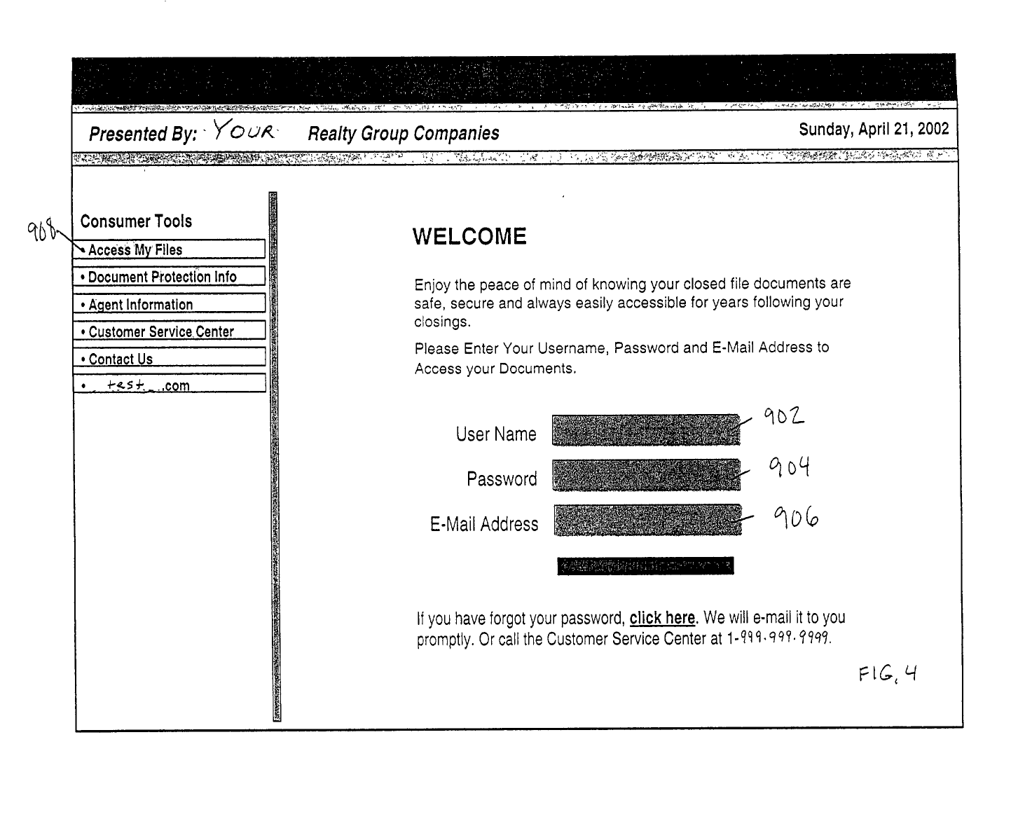

FIG. 3 shows a flow diagram of the process 510 of providing a consumer with on-line access to his or her real estate transaction documents. FIG. 4 shows an exemplary login screen for consumer access to system 900. At step 800, the consumer (buyer or seller) accesses consumer interface 514 via network 600. The consumer is prompted to input his or her user name, password, and e-mail address, as shown in FIG. 4. This information is received at document server 412a. Any suitable input device coupled to remote unit 512, such as a keyboard, mouse, electronic stylus or pen, touch screen, voice recognition feature, or similar means of inputting information in digital form, may be used by the consumer to input information via consumer interface 514.

At step 810, the consumer information is evaluated via computer programming logic of system 900 to determine whether the consumer is authorized to login to the system 900, for example, by comparing the combination of information to an on-line database of authorized users. In addition, programming logic is used to determine whether the consumer's authorized access time period has expired. As mentioned above, each consumer is assigned a time period of authorization, such as 5 years. If the consumer's authorized time period has expired, and the consumer has not requested additional access time, the consumer will be considered not authorized.

At step 820, programming logic of system 900 makes the determination of whether the consumer is or is not authorized to access the system 900. If the consumer is not authorized, access is denied. If the consumer is authorized, programming logic determines whether the current login session is the first login session for the consumer, at step 840. If it is the first time the consumer has connected to system 900, the consumer is prompted to input a new password to replace the system-assigned password, at step 850.

At step 860, the consumer is prompted to input additional information, such as his or her name, address, telephone number, and e-mail address, if changed. The consumer may return to this step at any time while logged in to update his or her personal information.

Once the consumer is successfully logged in to system 900, the consumer may select the “Access My Files” button 908 shown in FIG. 4 to proceed to access his or her transaction documents on-line. Activating this button 908 triggers a process for selecting the consumer's real estate transaction file for access by the consumer, step 870. If the consumer has multiple transaction files stored in system 900, the consumer may select the desired file(s) based on, for example, one or more of the following criteria: the agent or broker assigned to the file, the property address, property description, other property identifier, or closing date. Once the selection criteria are input by the consumer, system 900 executes programming logic to locate and retrieve the corresponding transaction file from database 414a.

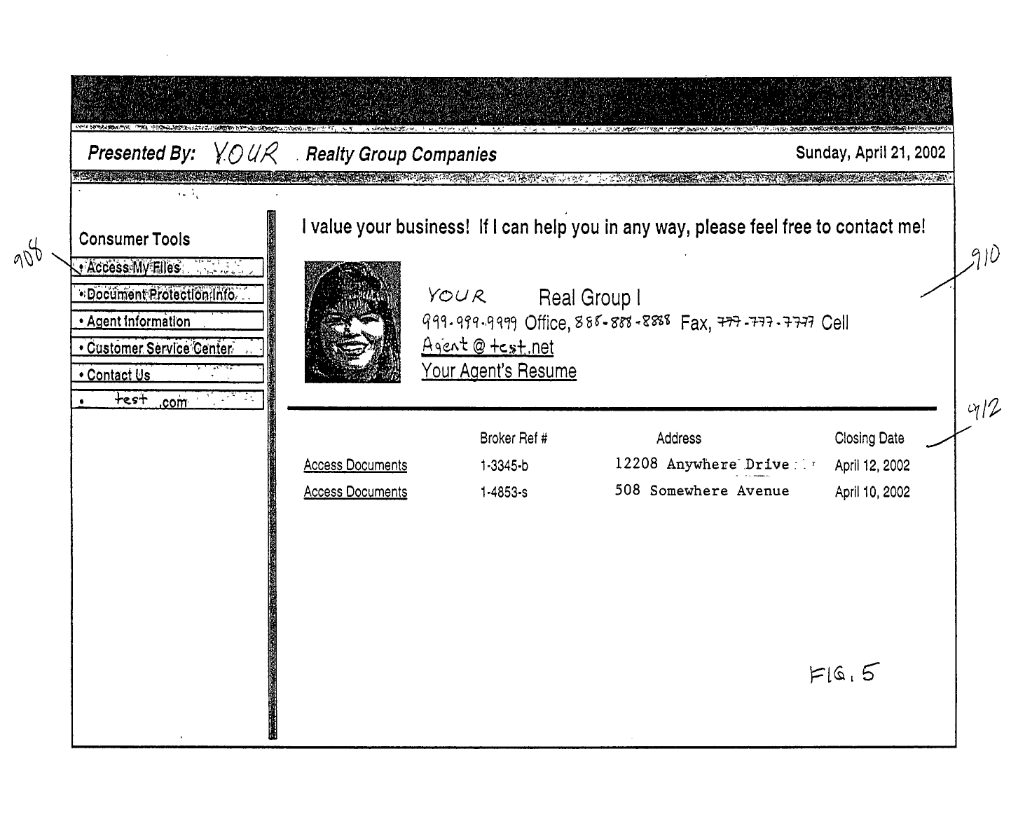

An example of a screen displaying the consumer's search results is shown in FIG. 5. In the upper portion of the screen 910, the consumer's agent contact information is provided, for convenience, so that the consumer may immediately contact the agent in the event of a question or problem. In the lower portion of the screen 912, a list of the consumer's transaction files matching the previously entered search criteria are displayed. As shown in FIG. 5, for each document, the following information is displayed: a hyperlink to the transaction document or documents (“Access Documents”), a unique identification number for the transaction file (“Broker Ref #), the property address (“Address”), and the transaction closing date (“Closing Date”). The Consumer selects the “Access Documents” hyperlink to view the transaction document(s). It is understood that other programming means could be used to select the documents to be viewed, such as clicking a button with a computer mouse or stylus, or pressing a key on a keyboard, for example.

When the consumer selects the documents to be accessed, step 880 of FIG. 3 is performed. Programming logic is used to display the document to the consumer via consumer interface 514. In the illustrated embodiment, a commercially available software application, such as Adobe Acrobat, is launched to enable viewing of the documents, preferably without any edit capabilities.

The steps involved in login and on-line document access for agents and real estate brokerage or agency office staff (via interfaces 614, 714) are substantially similar to the steps shown in FIG. 2 and described above, and therefore a description thereof is not repeated here.

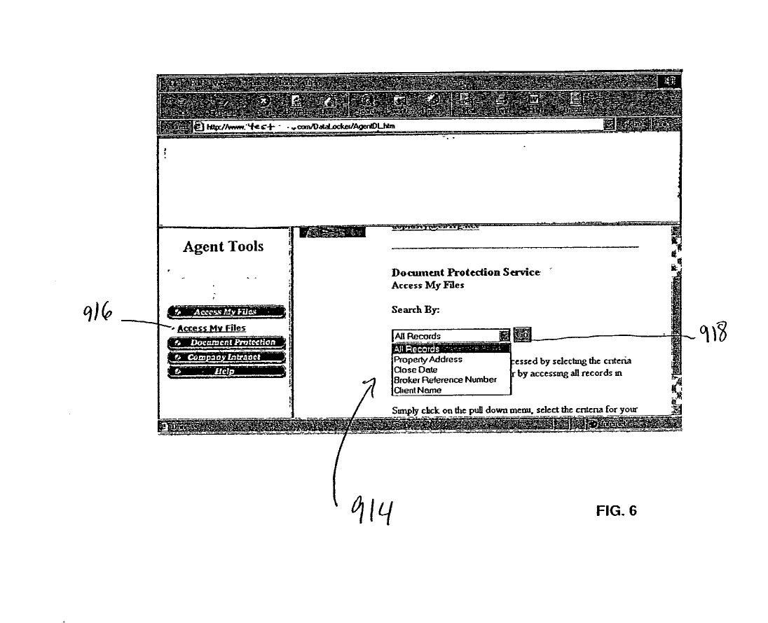

FIG. 6 shows an example document search screen displayed to an agent via agent interface 714. The agent selects the “Access My Files” button/link 916 to activate the searching capabilities. The agent then chooses the desired search criteria 914. A pull-down list is shown in FIG. 6, from which the agent selects from predetermined choices of search criteria, but it is understood that other means of selecting search criteria may be used, including activation of check boxes, radio buttons, or input of free text by the agent. In the illustrated embodiment, the agent may search for all records for all of his or her real estate transactions, or may search for transaction files by property address, closing date of the transaction, transaction identifier, or client name. Once the search criteria is selected, an activator 918 is activated to begin the search.

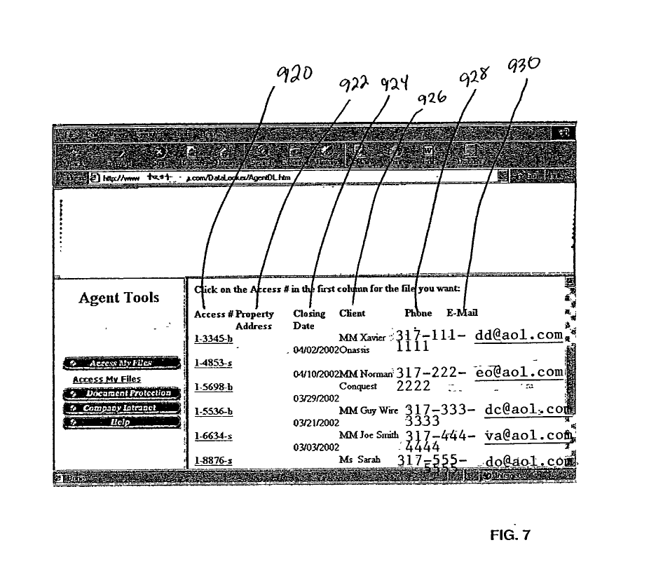

FIG. 7 shows a display of the results of the agent's document search. Displayed for each transaction file are the access number 920, property address 922, client name 924, client phone number 928, and client email address 930. Access number 920 is implemented as a hyperlink that can be activated by a mouse click or other action by a suitable input device. When activated, the document(s) in the transaction file corresponding to the selected access number are displayed using programming logic as described in connection with step 880 above.

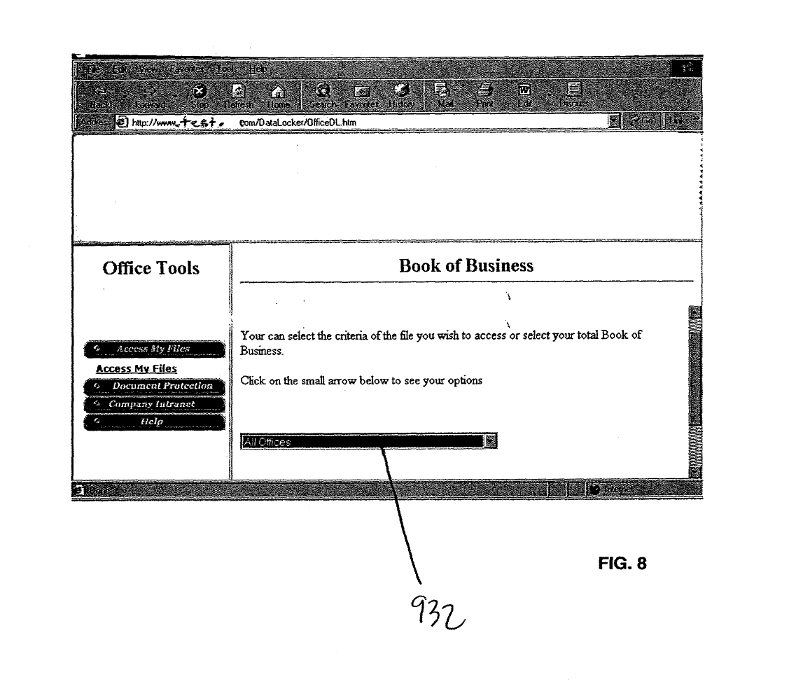

FIG. 8 shows a transaction file search request screen for a real estate agency or brokerage office, which is displayed via office interface 614. At the office level, all transaction files for a particular agency office location may be accessed. Via selection area 932, the office or offices for which transaction files are desired to be accessed are input or selected. As shown in FIG. 8, the office search criteria is selected from a pull-down list, however, it is understood that other selection mechanisms, such as those described above, may also be used. Selection of the search criteria from the pull-down list initiates the search. The selected files are retrieved and displayed as described above.

Although specific illustrated embodiments of the invention have been disclosed, it is understood by those of skill in the art that changes in form and details may be made without departing from the spirit and scope of the invention. The present invention is in no way limited to the details disclosed herein. Accordingly, the present invention is to be defined and limited solely by the scope of the claims.

We claim:

1. A method for providing a consumer with on-line access to a completed real estate transaction file, the method comprising the steps of:
verifying that a completed real estate transaction file is in compliance with applicable regulations,
preparing the file for conversion into digital form,
converting the file into a suitable digital form,
checking a quality of the converted file,
indexing the converted file for storage in an online database connected to a network,
storing the converted file in the online database in accordance with a predetermined document retention policy, and
providing the consumer with secure electronic access to the converted file over the network.

2. The method of claim 1, wherein the consumer is a buyer of real estate in the real estate transaction.

3. The method of claim 1, wherein the consumer is a seller of real estate in the real estate transaction.

4. The method of claim 1, wherein the completed real estate transaction file includes a plurality of documents.

5. The method of claim 1, wherein the completed real estate transaction file includes at least one of a listing file, a purchase file, and a closing file.

6. The method of claim 5, wherein the listing file comprises at least one of an original listing contract, a residential disclosure, and a lead-based paint disclosure.

7. The method of claim 5, wherein the purchase file comprises at least one of a purchase contract, a residential disclosure, and a lead-based paint disclosure.

8. The method of claim 5, wherein the closing file comprises at least one of a HUD statement, a title insurance commitment, and a survey.

9. The method of claim 1, wherein the applicable regulations comprise at least one of a state real estate license law, a realtor code, and a company policy.

10. The method of claim 1, wherein the step of preparing the file for conversion into digital form includes the step of bar-coding the file.

11. The method of claim 1, wherein the quality of the converted file being checked is accuracy.

12. The method of claim 1, further comprising the step of storing the converted file using a first backup storage method.

13. The method of claim 12, wherein the first storage method includes storing the converted file on an optical disk.

14. The method of claim 12, further comprising the step of storing the file using a second backup storage method.

15. The method of claim 14, wherein the second backup storage method includes storing the file in a vault.

16. The method of claim 1, wherein the document retention policy specifies a time period for storing the file.

17. The method of claim 1, wherein the step of providing the consumer with secure electronic access to the converted file over the network includes assigning a password to the consumer.

18. The method of claim 1, wherein the transaction file includes a first file associated with a buyer and a second file associated with a seller.

19. The method of claim 18, further comprising the step of checking the first and second files for compliance with applicable regulations.

20. The method of claim 19, further comprising the step of storing the first file separately from the second file.

21. The method of claim 20, further comprising the steps of designating the buyer as an authorized party with respect to the first file and designating the seller as an authorized party with respect to the second file.

22. A method for providing on-line access to a file resulting from a real estate transaction involving a real estate agent and a consumer represented by the real estate agent, the method comprising the steps of:
checking the file for compliance with applicable regulations,
storing the file in a memory coupled to a network in accordance with a policy,
designating the consumer and the real estate agent as authorized parties,
providing the authorized parties with access to the file over the network, and
denying access to the file by parties who are not designated as authorized parties.

23. A method for protecting files resulting from a consumer real estate transaction involving a real estate agent, a buyer represented by the real estate agent, and a seller represented by the real estate agent, the method comprising the steps of:
receiving a first file associated with the buyer,
receiving a second file associated with the seller,
checking the first and second files for compliance with applicable regulations,
storing the first file in a memory coupled to a network,
storing the second file separately from the first file,
designating the buyer and the real estate agent as authorized parties with respect to the first file,
designating the seller and the real estate agent as authorized parties with respect to the second file, and
limiting access to the first and second files to the respective designated parties.

24. A document protection system, comprising:
means for storing a file including at least one document relating to a closed real estate transaction involving a real estate agent and a consumer represented by the real estate agent,
means for enabling access to the file over a network by authorized parties,
means for designating the consumer and the real estate agent as authorized parties, and
means for denying access to the file by non-authorized parties.
